(19) United States
(12) Patent Application Publication
(10) Pub. No.: US 2017/0243087 A1
(43) Pub. Date: Aug. 24, 2017

(54) MOBILE APPARATUS, IMAGE PROCESSING APPARATUS, IMAGE PROCESSING SYSTEM, AND NON-TRANSITORY COMPUTER READABLE MEDIUM

(71) Applicant: FUJI XEROX CO., LTD., Tokyo (JP)

(72) Inventor: Yusaku AWATSU, Yokohama-shi (JP)

(73) Assignee: FUJI XEROX CO., LTD., Tokyo (JP)

(21) Appl. No.: 15/243,487

(22) Filed: Aug. 22, 2016

(30) Foreign Application Priority Data
Feb. 18, 2016 (JP) 2016-028848

(51) Int. Cl. G06K 15/00

(52) U.S. Cl. CPC G06K 15/007; G06K 15/4065; G06K 15/404

(57) ABSTRACT

According to an aspect of the invention, a mobile apparatus includes: a communication unit that performs wireless communication with an image processing apparatus; a first receiving unit that receives information indicating that printing is in progress from the image processing apparatus; a second receiving unit that receives information indicating that printing is completed from the image processing apparatus; and an output unit. When a connection state in the wireless communication with the image processing apparatus or a distance to the image processing apparatus satisfies a predetermined condition after the information indicating that printing is in progress is received from the image processing apparatus and before the information indicating that printing is completed is received from the image processing apparatus, the output unit outputs a message indicating that a printout output by the image processing apparatus is forgotten to be taken.

### CROSS-REFERENCE TO RELATED APPLICATIONS

This application is based on and claims priority under 35 U.S.C. 119 from Japanese Patent Application No.2016-028848 filed on Feb. 18, 2016.

### BACKGROUND

Technical Field

The present invention relates to a mobile apparatus, an image processing apparatus, an image processing system, and a non-transitory computer readable medium.

### SUMMARY

An aspect of the invention provides a mobile apparatus including: a communication unit that performs wireless communication with an image processing apparatus; a first receiving unit that receives information indicating that printing is in progress from the image processing apparatus; a second receiving unit that receives information indicating that printing is completed from the image processing apparatus; and an output unit, wherein when a connection state in the wireless communication with the image processing apparatus or a distance to the image processing apparatus satisfies a predetermined condition after the information indicating that printing is in progress is received from the image processing apparatus and before the information indicating that printing is completed is received from the image processing apparatus, the output unit outputs a message indicating that a printout output by the image processing apparatus is forgotten to be taken.

Another aspect of the invention provides an image processing apparatus including: a communication unit that performs wireless communication with a mobile apparatus; a first transmission unit that transmits information indicating that printing is in progress to the mobile apparatus; a lock unit that locks a printout output by the image processing apparatus to prevent from being taken out; and a second transmission unit that transmits information indicating that printing is completed to the mobile apparatus when the lock is unlocked.

Another aspect of the invention provides an image processing system including: a mobile apparatus; and an image processing apparatus, wherein the mobile apparatus includes: a communication unit that performs wireless communication with an image processing apparatus; a first receiving unit that receives information indicating that printing is in progress from the image processing apparatus; a second receiving unit that receives information indicating that printing is completed from the image processing apparatus; and an output unit, wherein when a connection state in the wireless communication with the image processing apparatus or a distance to the image processing apparatus satisfies a predetermined condition after the information indicating that printing is in progress is received from the image processing apparatus and before the information indicating that printing is completed is received from the image processing apparatus, the output unit outputs a message indicating that a printout output by the image processing apparatus is forgotten to be taken, and wherein the image processing apparatus includes: a communication unit that performs wireless communication with a mobile apparatus; a first transmission unit that transmits information indicating that printing is in progress to the mobile apparatus; a lock unit that locks a printout output by the image processing apparatus to prevent from being taken out; and a second transmission unit that transmits information indicating that printing is completed to the mobile apparatus when the lock is unlocked.

Another aspect of the invention provides a non-transitory computer readable medium storing a mobile terminal processing program causing a computer to function as: a communication unit that performs wireless communication with an image processing apparatus; a first receiving unit that receives information indicating that printing is in progress from the image processing apparatus; a second receiving unit that receives information indicating that printing is completed from the image processing apparatus; and an output unit, wherein when a connection state in the wireless communication with the image processing apparatus or a distance to the image processing apparatus satisfies a predetermined condition after the information indicating that printing is in progress is received from the image processing apparatus and before the information indicating that printing is completed is received from the image processing apparatus, the output unit outputs a message indicating that a printout output by the image processing apparatus is forgotten to be taken.

Another aspect of the invention provides a non-transitory computer readable medium storing an image processing program causing a computer to function as: a communication unit that performs wireless communication with a mobile apparatus; a first transmission unit that transmits information indicating that printing is in progress to the mobile apparatus; a lock unit that locks a printout output by the image processing apparatus so as not to be taken; and a second transmission unit that transmits information indicating that printing is completed to the mobile apparatus when the lock is unlocked.

### BRIEF DESCRIPTION OF DRAWINGS

Exemplary embodiments of the present invention will be described in detail based on the following figures, wherein:

FIG. 1 is a conceptual module configuration diagram of a configuration example of a first exemplary embodiment;

FIG. 2 is an explanatory diagram illustrating a system configuration example using the present exemplary embodiment;

FIG. 3 is an explanatory diagram illustrating a system configuration example using the present exemplary embodiment;

FIGS. 4A to 4F are explanatory diagrams illustrating an example of a case where print processing is performed at a store or the like;

FIGS. 5A to 5D are explanatory diagrams illustrating a processing example according to the first exemplary embodiment;

FIGS. 6A to 6D are explanatory diagrams illustrating a processing example according to the first exemplary embodiment;

FIGS. 7A to 7G are explanatory diagrams illustrating a processing example according to the first exemplary embodiment;

FIG. 8 is a flowchart illustrating a processing example according to the first exemplary embodiment;

FIG. 9 is a flowchart illustrating a processing example according to the first exemplary embodiment;

FIG. 10 is a conceptual module configuration diagram of a configuration example of a second exemplary embodiment;

FIG. 11 is a flowchart illustrating a processing example according to the second exemplary embodiment;

FIG. 12 is a conceptual module configuration diagram of a configuration example of a third exemplary embodiment;

FIG. 13 is a flowchart illustrating a processing example according to the third exemplary embodiment;

FIG. 14 is a block diagram illustrating a hardware configuration example of a computer for realizing the present exemplary embodiment; and

FIG. 15 is a block diagram illustrating a hardware configuration example of a computer for realizing the present exemplary embodiment.

### DETAILED DESCRIPTION

Hereinafter, examples of various exemplary embodiments for realizing the invention will be described with reference to the accompanying drawings.

### First Exemplary Embodiment

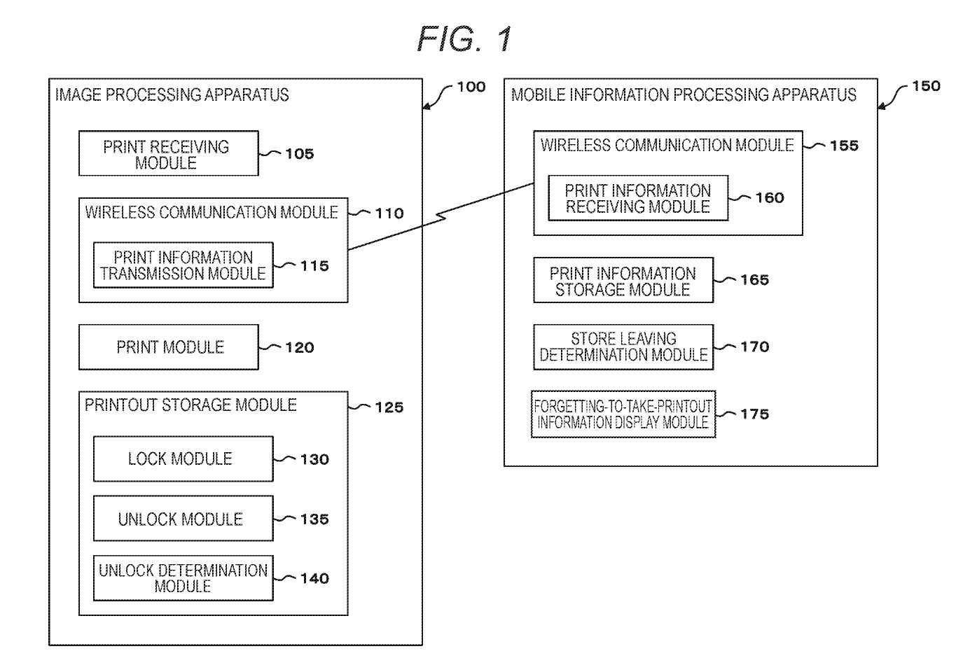

FIG. 1 is a conceptual module configuration diagram of a configuration example of a first exemplary embodiment.

Here, a module generally refers to a component such as software (computer program), hardware, or the like that is logically separable. Thus, the module in the present exemplary embodiment means not only a module in a computer program but also a module in a hardware configuration. Therefore, in the present exemplary embodiment, a computer program (a program causing a computer to execute each step, a program causing a computer to function as each unit, a program causing a computer to realize each function), a system, and a method for functioning as the module will also be described.

Here, for convenience of description, “store”, “be stored”, and a word similar to these terms are used, but, in a case of the exemplary embodiment related to a computer program, these words mean “causing a computer program to store in a memory device” or “controlling a computer program to store in a memory device”.

In addition, a module corresponds to a function in a one-to-one manner. However, in the implementation, one module may be configured by one program, or multiple modules may be configured by one program. In contrast, one module may be configured by multiple programs. Further, multiple modules may be executed by one computer, and one module may be executed by multiple computers in a distributed environment or a parallel environment. One module may include another module.

Hereinafter, the term “connection” may be used in a case of logical connection (data exchange, instruction, reference relationship between data, or the like), in addition to the physical connection.

The term “predetermined” means that it is determined prior to the processing as a target, not only before the processing according to the present exemplary embodiment is started, but also even after the processing according to the present exemplary embodiment is started, as long as the processing as a target is not started, and the term “predetermined” may be used, to include the meaning that it is determined according to the status and state at that time or according to the status and state thus far. In a case where there are multiple “predetermined values”, multiple “predetermined values” may have respectively different values, and may have two or more same values (of course, including all same values).

Further, the description of “in a case of A, B is performed” may be used to mean “it is determined whether or not A, in a case where it is determined that A, B is performed”. Here, “in a case of A, B is performed” does not include a case where it is unnecessary to determine whether or not A.

Further, the system or the device is configured by multiple computers, hardware, other devices, or the like that are connected to each other via a communication tool such as a network (including one-to-one correspondence communication connection).

The system or the device may be configured by one computer, hardware, a device, or the like. The term “apparatus” and the term “system” are used as terms that are synonymous with each other. Of course, the term “system” does not include a social “structure” (social system) that is only an artificial agreement.

Further, the processing is performed by reading the information as a target from a memory device, and then processing results are written in the memory device, for each processing according to each module, or for each processing in a case where multiple processes are performed in a module. Therefore, the description may be omitted in some cases for reading from the memory device before processing, and for writing to the memory device after processing. As the memory device, a hard disk, a random access memory (RAM), an external storage medium, a memory device via a communication line, a register in a central processing unit (CPU), or the like may be included.

### First Embodiment

As illustrated in the example of FIG. 1, an image processing apparatus 100 according to a first exemplary embodiment outputs a printout, and includes a print receiving module 105, a wireless communication module 110, a print module 120, and a printout storage module 125. The image processing apparatus 100 is, for example, a copier, a facsimile, a printer, a multifunction machine (image processing apparatus having two or more functions of a scanner, a printer, a copier, a facsimile, and the like. Here, the image processing apparatus 100 has any one of functions of a printer and a copier). The image processing apparatus 100 can be connected to a mobile information processing apparatus 150 in the possession of the user via a wireless communication network.

As an example, the image processing apparatus 100 is provided at a store which many unspecified customers go in and out such as a convenience store.

When a printer performs printing, in a case where it takes some time to finish printing, there is an idea to use a printing waiting time for other useful work. This is the same in facilities such as a convenience store. For example, there is an idea to use the printing waiting time at a convenience store for shopping at the convenience store, withdrawing money from an ATM at the convenience store, reading a book, or taking a rest at the rest area in the convenience store. In addition, during printing at a convenience store, when other people are waiting their turn, some users may feel pressure, and thus want to be away from the printer during printing. However, when the user is away from the printer during printing, there is a problem in which a printout can be viewed by others or a printout can be taken away by other people. A related-art technique can respond to the problem in which a printout can be viewed by others or a printout can be taken away by other people. However, when the user performs another action during printing at a convenience store or the like, the user becomes immersed and concentrates on another action as described above, and thus the user may leave the store forgetting the printout.

A related-art technique has a configuration that performs a print instruction via network, and then determines whether or not the user who performed the print instruction is present within a certain distance from the printer, and displays forgetting-to-take-printout for a certain period of time in a case where the user is present within the certain distance.

In a use case such as described above, a related-art technique has the following problems.

1-1. After the print instruction, the user engages in different action within a limited range in a convenience store, and thus the user is always present within a certain distance, thereby always displaying forgetting-to-take-printout.

1-2. Alternatively, the user is not within a limited range, thereby always displaying forgetting-to-take-printout.

In a case of 1-1, in the convenience store where many unspecified customers go in and out, particularly, always displaying forgetting-to-take-printout causes inconvenience to other customers that are not associated with the printing. In a case of 1-2, the forgetting-to-take-printout notification basically cannot be made.

In addition, in the case where multiple persons perform printing and multiple printouts are present in multiple stackers, it is difficult to notice that which user forgot to take the printout.

That is, in a related-art technique, a print instruction is performed at a place away from the printer and the user is notified of forgetting-to-take-printout in a case where the user approaches the printer.

Thus, there is no problem in the mechanism in which the forgetting-to-take-printout determination or notification is performed on the printer side.

However, as in the above-described use case, in a case where the print instruction is directly performed on the printer and the user is away from the printer forgetting printing, it is difficult to perform the forgetting-to-take-printout notification on the printer side, and effectively notify the user of the forgetting-to-take-printout.

A related-art technique is directed to a case of performing a print instruction via network, and does not presuppose a case where a print instruction is performed on the printer and then the user engages in another action in the store. Thus, the technique does not presuppose a case where even though the user is present in the vicinity of the printer, the user forgets printing while engaging in another action, and thus the user leaves the store.

Therefore, in the above-described use case, the detection processing of the forgetting-to-take-printout in the related-art technique becomes the following operation depending on detection timing.

2-1. In a case where the user leaves the store before the detection timing of the forgetting-to-take-printout, the printout is treated as a forgotten-to-be-taken printout, and thus the printout is cut by a shredder.

2-2. In a case where the user leaves the store after the detection timing of the forgetting-to-take-printout (staying-in-store), the printout is held.

Although there is no particular problem in the case of 2-2, the printout is cut by a shredder in the case of 2-1. Thus, in order to obtain another printout, the user has to visit the store again and reprint a printout at an additional expense. Therefore, the cost of reprinting is imposed on the user. In addition, the optimal setting of the detection timing of forgetting-to-take-printout is possible for each installation environment by the administrator of the printer. Therefore, it is necessary to determine the optimum value in some way.

However, in an environment where many unspecified customers go in and out such as a convenience store, it is very difficult to set the optimum value. For example, when the optimum value is set to 10 minutes, depending on the user, it is also conceivable that the user finishes shopping in three minutes and leaves forgetting the printout left behind. In this case, since the user may be away for the remaining seven minutes, even though the forgetting-to-take-printout notification is possible after that, it costs a lot to return to the store to take the printout

Further, the printout is cut by a shredder, and thus reprinting costs and reprinting time are also required. On the other hand, in order to avoid these problems, in a case where the optimum value is set to a short period of time such as one minute, even though the user engages in an action such as shopping without forgetting printing, the user is regarded as forgetting to take the printout, and thus an unnecessary forgetting-to-take-printout notification is made. That is, the timing for determining forgetting the printout is not uniform and depends on the user, and thus it is not appropriate to determine forgetting to take the printout using a time origin.

In public facilities at which many unspecified customers go in and out such as a convenience store, when constructing a system that can ensure security and effectively use the printing waiting time, there are many cases where the user becomes immersed and concentrates on another action during printing and thus the user leaves the store forgetting the printout. Under such circumstances, in the related-art techniques, there are the following problems. JP-A-2008-229913

Problem 1: Notification around a copy machine may cause inconvenience to other customers who are not associated with the printing (sound: loud, light: distracting).

Problem 2: It is difficult to notice that which user forgot to take the printout.

Problem 3: The cost of reprinting (reprinting costs and travel time to return to take the print) is imposed on the user.

Problem 4: The timing of forgetting printing is not uniform, and thus it is not appropriate to determine forgetting to take the printout using a time origin.

The first exemplary embodiment introduces a user leaving determination mechanism. For example, in a case where, after a print instruction is performed at a convenience store, it is determined that the user has left the convenience store without taking the printout, the user leaving determination mechanism makes the user return to the convenience store (prevent a cost increase of the user by forgetting to take the printout), by notifying the user of forgetting to take the printout using the mobile information processing apparatus 150 in the possession of the user (notifying only appropriate user).

Therefore, it is possible to prevent other customers from being inconvenienced by performing the forgetting-to-take-printout prevention notification on the mobile information processing apparatus 150 in the possession of the user. Only the user who forgot to take the printout is notified, and thus it becomes clear who forgot to take the printout. Therefore, it is possible to prevent a cost increase of the user by forgetting to take the printout (re-printing cost and travel time to return to take the printout). When the user leaves the convenience store (regardless of the period of time for which the printout is left behind, the timing at which the printout is determined as an article left behind), the user can be notified of the forgetting-to-take-printout.

The print receiving module 105 receives a print instruction from the user. The print instruction may include print document data. For example, print document data stored in the memory (USB memory, the mobile information processing apparatus 150, or the like) that is brought by the user may be set as a print target, or print document data stored in cloud memory or the like may be set as a print target.

The wireless communication module 110 includes a print information transmission module 115. The wireless communication module 110 performs wireless communication with the mobile information processing apparatus 150.

The print information transmission module 115 transmits print information to the mobile information processing apparatus 150 via the wireless communication module 110. The print information includes information indicating that printing is in progress, and information indicating that printing is completed. That is, the print information transmission module 115 transmits information indicating that printing is in progress to the mobile information processing apparatus 150. In a case where a lock is released, the print information transmission module 115 transmits information indicating that printing is completed to the mobile information processing apparatus 150.

The print module 120 prints the information (print document data) received by the print receiving module 105, and outputs the information to the printout storage module 125.

The printout storage module 125 includes a lock module 130, an unlock module 135, and an unlock determination module 140. The printout storage module 125 stores the printout that is output by the print module 120. The printout storage module 125 may be a storage cabinet with a key.

The lock module 130 locks the printout storage module 125. That is, the lock module 130 locks the printout storage module 125 so as not to take the printout that is output by the print module 120 of the image processing apparatus 100.

The unlock module 135 unlocks the storage cabinet with a key. That is, the unlock module 135 unlocks the printout storage module 125.

The unlock determination module 140 performs verification, and determines whether or not to unlock the printout storage module 125.

The mobile information processing apparatus 150 includes a wireless communication module 155, a print information storage module 165, a store leaving determination module 170, and a forgetting-to-take-printout information display module 175. The mobile information processing apparatus 150 is, for example, a mobile phone, a smart phone, a mobile device, a wearable computer, a theft prevention tag, or the like. The mobile information processing apparatus 150 is in the possession of the user and a print instruction is performed on the mobile information processing apparatus 150.

The wireless communication module 155 includes a print information receiving module 160. The wireless communication module 155 performs wireless communication with the image processing apparatus 100.

The print information receiving module 160 receives the print information on the print target in the image processing apparatus 100, from the image processing apparatus 100. The print information includes information indicating that printing is in progress, and information indicating that printing is completed. That is, the print information receiving module 160 receives information indicating that printing is in progress from the image processing apparatus 100. The print information receiving module 160 receives information indicating that printing is completed from the image processing apparatus 100.

The print information storage module 165 stores the received print information. The print information storage module 165 stores information indicating that printing is in progress, and then may remove information indicating that printing is in progress in a case where information indicating that printing is completed is received.

The store leaving determination module 170 determines whether or not the user (user who possesses the mobile information processing apparatus 150) has left from the store at which the image processing apparatus 100 is provided. Specifically, when the connection status of the wireless communication between the image processing apparatus 100 and the mobile information processing apparatus 150 is less than (equal to or less than) a predetermined first threshold value, or when the distance to the image processing apparatus 100 is greater than (equal to or larger than) a predetermined c2nd threshold value, it is determined whether or not the user has left the store. In a case where these conditions are satisfied, it is determined that the user has left the store. Therefore, when the user leaves the store (regardless of the period of time for which the printout is left behind, the timing at which the printout is determined as an article left behind), it is possible to notify the user of the forgetting-to-take-printout.

When it is determined that the user has left the store, the forgetting-to-take-printout information display module 175 displays forgetting-to-take-printout information on the mobile information processing apparatus 150. It is possible to notify only the user who forgot to take the printout. After receiving the information indicating that printing is in progress from the image processing apparatus 100, and before receiving the information indicating that printing is completed from the image processing apparatus 100, in a case where the connection status of the wireless communication with the image processing apparatus 100 or the distance to the image processing apparatus 100 satisfies a predetermined condition, the forgetting-to-take-printout information display module 175 outputs a message indicating that the user forgot to take the printout that is outputted by the image processing apparatus 100.

Here, the “predetermined condition” may be a condition that the connection status of the wireless communication with the image processing apparatus 100 is less than (equal to or less than) a predetermined first threshold value, or a condition that the distance to the image processing apparatus 100 is greater than (equal to or larger than) a predetermined c2nd threshold value.

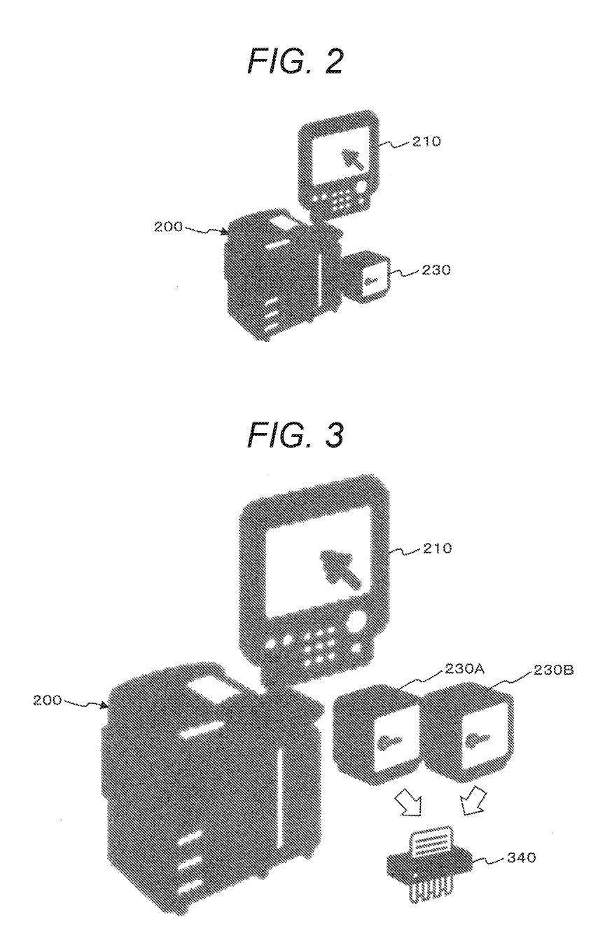

FIG. 2 is an explanatory diagram illustrating a system configuration example using the present exemplary embodiment.

The image processing apparatus 200 includes a display and instruction receiving device 210 and an output box 230. The display and instruction receiving device 210 has a function of the print receiving module 105, and the image processing apparatus 200 has a function of the wireless communication module 110 and the print module 120.

The output box 230 has a function of the printout storage module 125. During printing, even though the user has left the place (the vicinity of the image processing apparatus 200), the image processing apparatus 200 outputs a printout to the output box 230 for storing the printout such that the printout is not arbitrarily viewed by other people or the printout is not taken away by other people. The output box 230 may be a box with a key (personal identification number).

FIG. 3 is an explanatory diagram illustrating a system configuration example using the present exemplary embodiment (in particular, a second exemplary embodiment and a third exemplary embodiment). The image processing apparatus 200 includes the display and instruction receiving device 210, the output box 230A, the output box 230B, and a shredder 340. The multiple output boxes 230 (in the example of FIG. 3, the output boxes 230A and 230B) can store printouts by the print instructions from multiple users (in the example of FIG. 3, two persons). A storage time is set to each output box 230 (for example, 30 minutes, or the like). When the storage time has elapsed, the printout in the output box 230 is automatically shredded by the shredder 340.

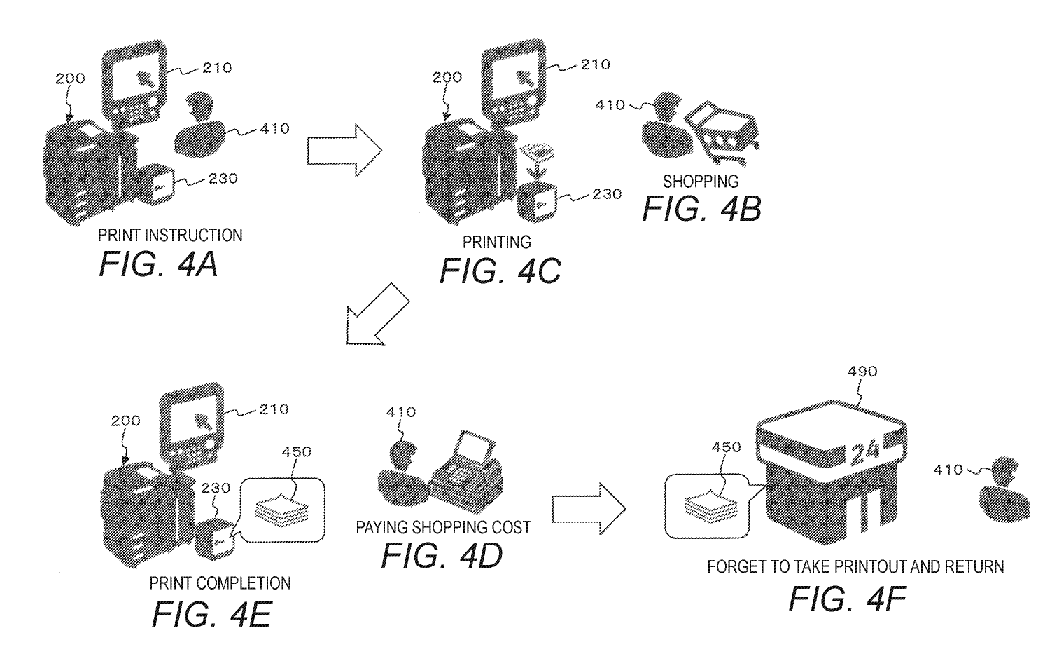

FIGS. 4A to 4F are explanatory diagrams illustrating an example of a case where print processing is performed at a convenience store or the like. FIGS. 4A to 4F illustrate an example of a case where the present exemplary embodiment is not used.

A. “Print Instruction”

In the example of FIG. 4A, a user 410 that enters a convenience store or the like performs a print instruction using the display and instruction receiving device 210 of the image processing apparatus 200. Here, the print instruction is intended to store the printout to the output box 230.

B. “Shopping”

In the example of FIG. 4B, after the print instruction, the user 410 is in shopping at the convenience store or the like.

C. “Printing”

In the example of FIG. 4C, even when the user 410 is in shopping, the image processing apparatus 200 performs printing and stores a printout in the output box 230.

D. “Paying Shopping Cost”

In the example of FIG. 4D, the user 410 is in paying a shopping cost.

E. “Print Completion”

In the example of FIG. 4E, printing is completed, and then the printout 450 is stored in the output box 230.

F. “Forgetting-To-Take-Printout and Returning”

In the example of FIG. 4F, the user 410 returns from the convenience store 490 forgetting to take the printout 450. During printing, when the user is away from the convenience store and performs another action (shopping, or the like), the user may forget the print instruction and leave the convenience store 490.

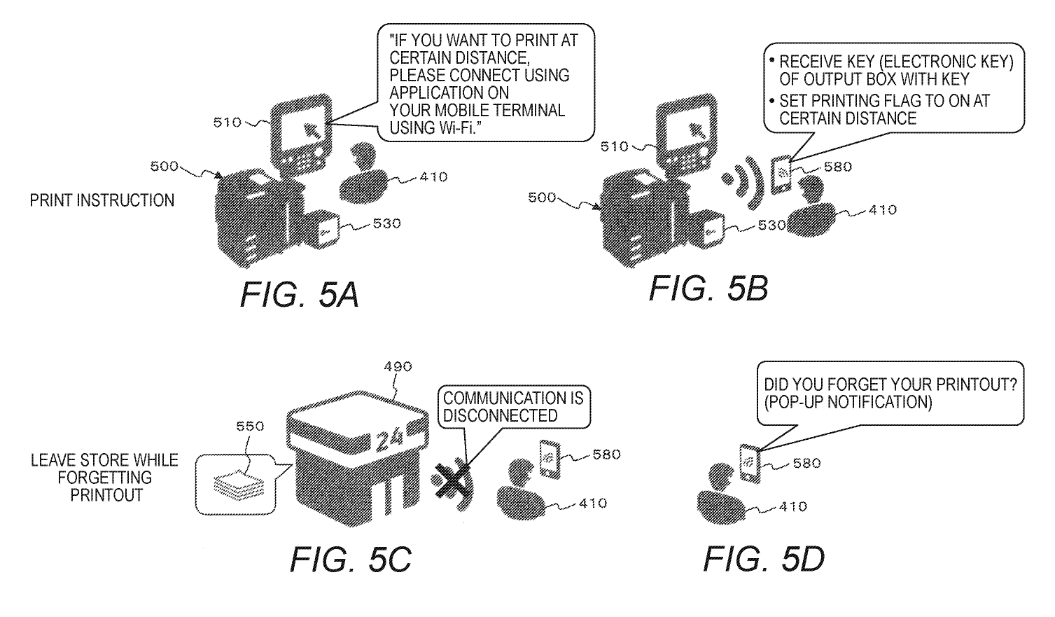

FIGS. 5A to 5D are explanatory diagrams illustrating a processing example according to the first exemplary embodiment.

In the example of FIG. 5A, the image processing apparatus 500 includes a display device 510 and an output box 530 with a key. The display device 510 has a function of the print receiving module 105, and the image processing apparatus 500 has a function of the wireless communication module 110 and the print module 120.

The output box 530 with a key has a function of the printout storage module 125.

In a case where the print instruction is performed by the user 410, for example, “If you want to print at a certain distance, please connect using the application on your mobile terminal 580 via Wi-Fi” is displayed on the display device 510. The wireless communication such as Bluetooth (registered trademark) other than Wi-Fi can be used.

The store leaving may be detected using GPS information. Instead of the mobile terminal 580, a theft prevention tag may be physically used.

In the example of FIG. 5B, the mobile terminal 580 and the image processing apparatus 500 are connected to each other.

The mobile terminal 580 receives the key (electronic key) of the output box 530 with a key, and sets a printing flag (in-printing flag) to ON. Then, the user 410 is away from the image processing apparatus 500, and does shopping or the like.

In the example of FIG. 5C, the user 410 leaves the convenience store 490 forgetting the printout 550. At that time, wireless communication connection between the mobile terminal 580 and the image processing apparatus 500 is disconnected.

In the example of FIG. 5D, “Did you forget your printout?” is displayed on the display screen of the mobile terminal 580 using a pop-up notification. Here, the display condition is that the printing flag is ON and the Wi-Fi connection is in a disconnected state.

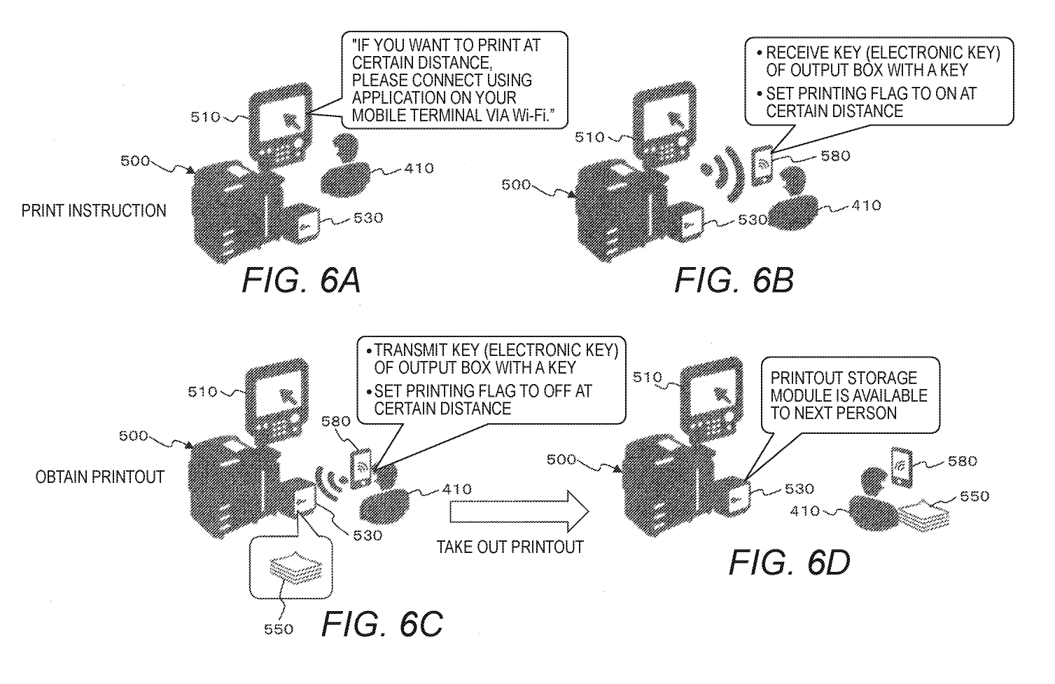

FIG. 6A to 6D are explanatory diagrams illustrating a processing example (example in which the user takes the printout without forgetting) according to the first exemplary embodiment.

The examples of FIGS. 6A and 6B are similar to the examples of FIGS. 5A and 5B.

In the example of FIG. 6C, the mobile terminal 580 transmits the key (electronic key) of the output box 530 with a key to the image processing apparatus 500, unlocks the output box 530 with a key, and sets the printing flag to OFF, in accordance with the operation of the user 410.

In FIG. 6D, the user 410 takes a printout 550 from the output box 530 with a key, and the image processing apparatus 500 can be used by the next person.

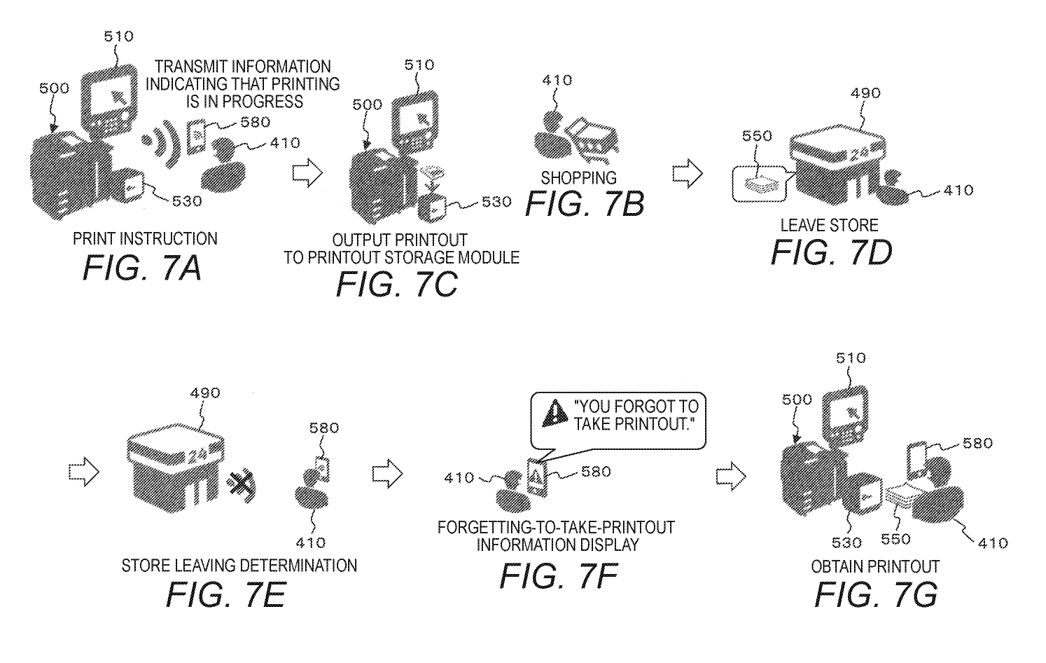

FIGS. 7A to 7G are explanatory diagrams illustrating a processing example according to the first exemplary embodiment.

A. Print Instruction

In the example of FIG. 7A, the user 410 that enters a convenience store or the like performs a print instruction using the display device 510 of the image processing apparatus 500. Here, the print instruction is intended to store a printout in the output box 530 with a key. The image processing apparatus 500 transmits information indicating that printing is in progress to the mobile terminal 580 (a1).

B. Shopping

In the example of FIG. 7B, after the print instruction, the user 410 is in shopping at the convenience store or the like.

C. Output Printout to Printout Storage Module 125

In the example of FIG. 7C, even when the user 410 is in shopping, the image processing apparatus 500 performs printing and stores a printout in the output box 530.

D. Store Leaving

In the example of FIG. 7D, after paying a shopping cost, the user 410 leaves the convenience store 490 forgetting the printout 550.

E. Store Leaving Determination

In the example of FIG. 7E, as the user 410 has left the convenience store 490, the wireless communication connection between the image processing apparatus 500 and the mobile terminal 580 is disconnected.

F. Forgetting-To-Take-Printout Information Display

In the example of FIG. 7F, the mobile terminal 580 determines that the user 410 leaves the convenience store 490. For example, “You forgot to take the printout.” is displayed on the display screen of the mobile terminal 580.

G. Obtaining Printout

In the example of FIG. 7G, the user 410 returns to the image processing apparatus 500 in the convenience store 490, and takes out the printout 550 from the output box 530 with a key.

The image processing apparatus 500 can be used by the next person.

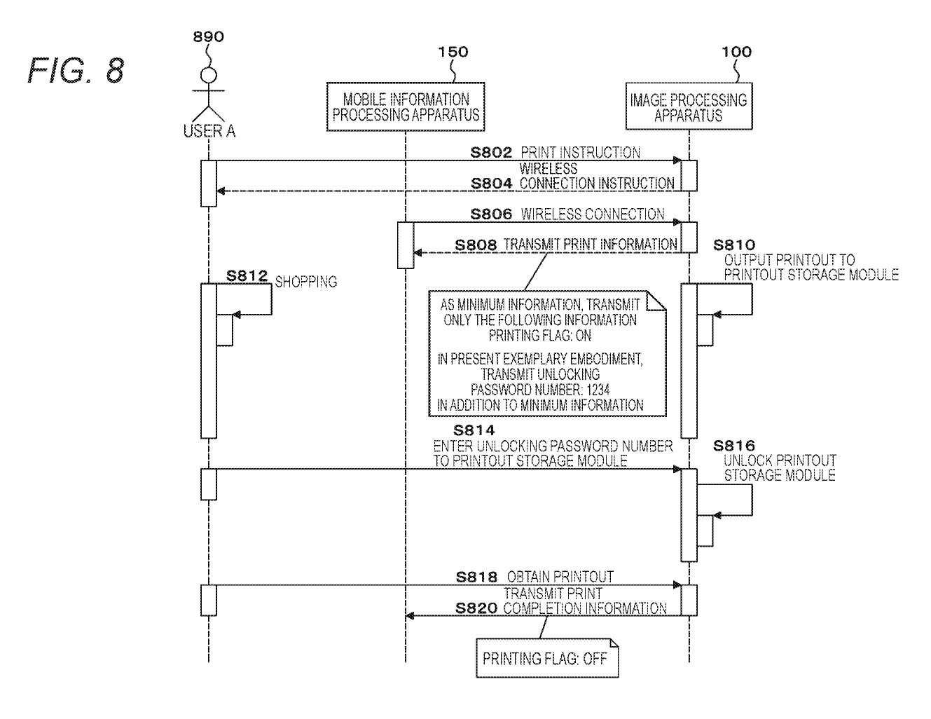

FIG. 8 is a flowchart illustrating a processing example according to the first exemplary embodiment. FIG. 8 illustrates the flow of the processing in a case where although the user performs printing at a convenience store or the like and does shopping during printing but obtains a printout without forgetting.

In step S802, a user A 890 instructs the image processing apparatus 100 to perform printing.

In step S804, the image processing apparatus 100 instructs the user A 890 to perform wireless connection.

The user A 890 performs a print instruction on the image processing apparatus 100 of the convenience store. The image processing apparatus 100 instructs “wireless connection between the mobile information processing apparatus 150 of the user A 890 and the image processing apparatus 100”. The order of the wireless connection and the order of the print instruction may be changed.

In step S806, the mobile information processing apparatus 150 performs a wireless communication connection to the image processing apparatus 100.

In step S808, the image processing apparatus 100 transmits the print information to the mobile information processing apparatus 150. As minimum information, only “printing flag: ON” is transmitted.

In the present exemplary embodiment, “unlocking password number: 1234” is transmitted in addition to the minimum information.

The user A 890 performs a wireless communication connection to the image processing apparatus 100 from the mobile information processing apparatus 150, in accordance with the instruction of the image processing apparatus 100. When wireless connection is established, the image processing apparatus 100 transmits the printing flag information and the unlocking password number information, to the mobile information processing apparatus 150, as the print information. The mobile information processing apparatus 150 stores the printing flag information and the unlocking password number information that are received.

In the wireless connection, Bluetooth (registered trademark) or the like other than Wi-Fi may be used, and short range wireless communication that can cover the range in the store is preferably used.

The print information may be information simply indicating that printing is in progress. The unlock information (password number information) of the printout storage module 125 may be transferred to the user A 890 (user A 990) by displaying on the image processing apparatus 100 or printing on paper.

The print information that is transmitted from the image processing apparatus 100 to the mobile information processing apparatus 150 may include the following information.

1.File Name: This is the name of the file for which the print instruction is performed. For example, the file name is “Sample.pdf” or the like.

2. Print Date and Time: This is information on the date and time when the print instruction is performed. For example, the print date and time is Dec. 12, 2015 12:00 or the like.

3.Print Store: This indicates information on the store at which the print instruction is performed. For example, the print store is “Minatomirai branch” and the like.

4. Storage Cabinet Number: This is a number indicating the printout storage module 125 in which the printout is stored, in a case where there are multiple printout storage modules 125. For example, the storage cabinet number is “No. 1” or the like.

5. Storage Time: This is a period of time for which the printout is held in the printout storage module 125. When the storage time has elapsed, the printout is cut. For example, the storage time is “Dec. 12, 2015 12:30” or the like.

6. Unlocking Password Number: This is a password number of the printout storage module 125. For example, the password number is “12345678” or the like.

7. Information indicating that Printing is in Progress (or Printout is obtained): This indicates whether or not printing is in progress (or whether or not the printout is already obtained). The information is any one of “printing is in progress (or incomplete)” and “printing completion (printout is obtained)”.

In step S810, the image processing apparatus 100 outputs the print information to the printout storage module 125.

When the transmission of the print information to the mobile information processing apparatus 150 is completed, the image processing apparatus 100 starts the instructed printing. The printed paper is output to the printout storage module 125 that is locked.

In a case where printing is completed, the image processing apparatus 100 may notify the user A 890 (mobile information processing apparatus 150) of printing completion using wireless communication.

The unlocking password number may be transmitted at the time of printing completion.

In step S812, the user A 890 does shopping.

The user A 890 (user A 990) does shopping in the convenience store using printing time using a printing time.

Shopping is only an example, and taking a rest, stand-up reading, toilet, or the like is possible as long as the user stays in the store.

In step S814, the user A 890 enters the unlocking password number to the printout storage module 125 into the image processing apparatus 100.

The user A 890 enters the password number that is received in step S808 into the printout storage module 125.

The password number may not be manually entered by the user A 890 (user A 990). The image processing apparatus 100 and the mobile information processing apparatus 150 are connected to each other via wireless communication, and an unlocking key may be authenticated by transmitting the unlocking key via wireless communication.

In step S816, the image processing apparatus 100 unlocks the printout storage module 125.

If there is no problem in the authentication, the printout storage module 125 performs unlocking.

In step S818, the user A 890 obtains the printout from the printout storage module 125 of the image processing apparatus 100.

In step S820, the image processing apparatus 100 transmits print completion information to the mobile information processing apparatus 150, and sets the printing flag to OFF.

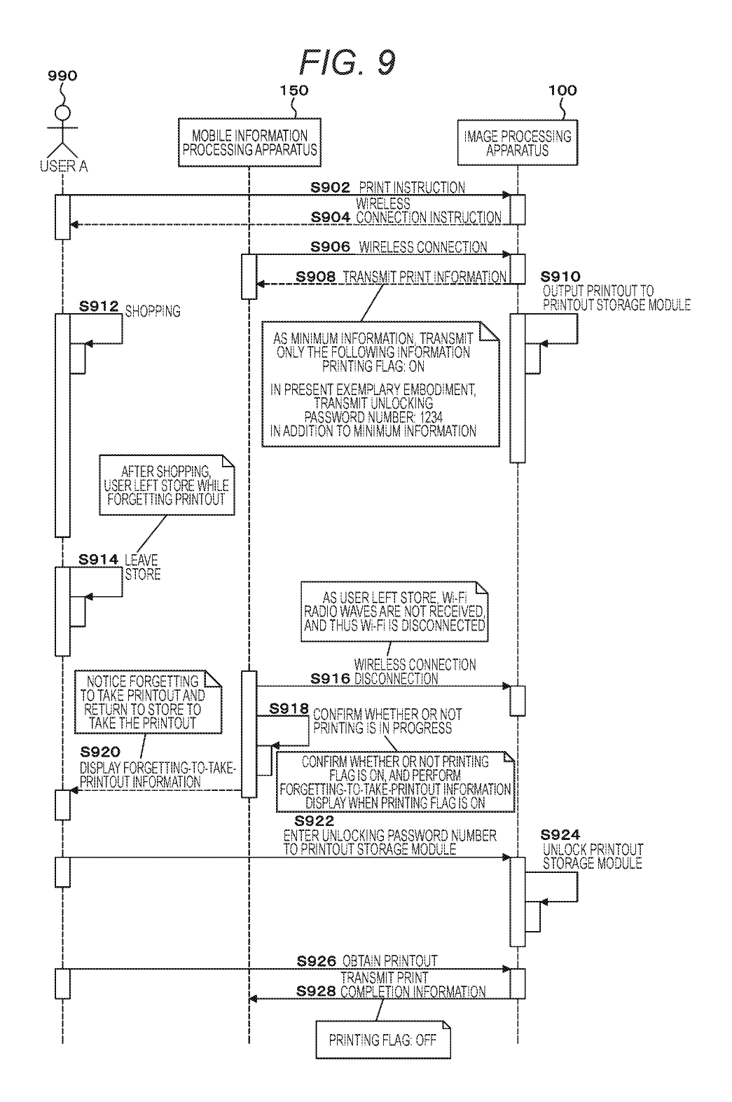

FIG. 9 is a flowchart illustrating a processing example according to the first exemplary embodiment. FIG. 9 illustrates the flow of the processing in a case where the user performs printing at a convenience store or the like and becomes immersed in shopping during printing, and thus the user leaves the store forgetting the printout.

The processing from step S902 to step S912 is similar to the processing from step S802 to step S812 in the flowchart illustrated in the example of FIG. 8. The processing from step S922 to step S928 is similar to the processing from step S814 to step S820 in the flowchart illustrated in the example of FIG. 8.

In step S902, a user A 990 instructs the image processing apparatus 100 to print.

In step S904, the image processing apparatus 100 instructs the user A 990 to perform wireless connection.

In step S906, the mobile information processing apparatus 150 performs wireless connection to the image processing apparatus 100.

In step S908, the image processing apparatus 100 transmits the print information to the mobile information processing apparatus 150. As minimum information, only “printing flag: ON” is transmitted.

In the present exemplary embodiment, “unlocking password number: 1234” is transmitted in addition to the minimum information.

In step S910, the image processing apparatus 100 outputs the printout to the printout storage module 125.

In step S912, the user A 990 does shopping.

In step S914, the user A 990 leaves the store. After shopping, the user A 990 leaves the store forgetting the printout.

The user A 990 forgot printing while shopping, and thus leaves the store after shopping.

In step S916, the mobile information processing apparatus 150 disconnect wireless connection. As the user A 990 has left the store, Wi-Fi radio waves are not received, and thus Wi-Fi is disconnected.

As the user A 990 has left the store, a physical distance from the store increases, and thus connection in short range wireless communication is disconnected.

The mobile information processing apparatus 150 regards the user as left the store when wireless connection is disconnected.

In the store leaving determination, wireless communication may not be used. In a case where position information (GPS information) or the like of the image processing apparatus 100 is included in the print information, and the position (GPS information) of the mobile information processing apparatus 150 is larger than a predetermined distance, the user may be regarded as left the store.

Even in a case where wireless communication is used, a determination condition other than disconnection may be used. For example, even though wireless connection is not disconnected, in a case where radio field intensity is smaller than a predetermined threshold value, it may be determined that the user has left the store.

In step S918, the mobile information processing apparatus 150 confirms whether or not printing is in progress. The mobile information processing apparatus 150 confirms whether or not the printing flag is ON, and performs forgetting-to-take-printout information display when the printing flag is ON.

In a case where it is determined that the user has left the store, the mobile information processing apparatus 150 refers to the print information that is stored in the mobile information processing apparatus 150.

The order of the user leaving check in the step S916 and the order of the confirmation processing whether or not printing is in progress in the step S918 may be changed.

In a case where whether or not printing is in progress is firstly confirmed, when printing is not in progress, subsequent processing thereof may not be performed.

In step S920, the mobile information processing apparatus 150 displays the forgetting-to-take-printout information to the user A 990. The user A 990 notices forgetting to take the printout, and returns to the store to take the printout.

In a case where the information indicating that printing is in progress is stored, the mobile information processing apparatus 150 notifies information indicating that the user may forget to take printout, using the display device or the like of the mobile information processing apparatus 150.

The method for notifying forgetting to take printout is not particularly limited, as long as it is a method that can be used in the mobile information processing apparatus 150, such as a notification using voice or message, a notification using vibration, or the like.

In step S922, the user A 990 enters the unlocking password number to the printout storage module 125 into the image processing apparatus 100.

In step S924, the image processing apparatus 100 unlocks the printout storage module 125.

In step S926, the user A 990 obtains the printout from the image processing apparatus 100.

In step S928, the image processing apparatus 100 transmits the print completion information to the mobile information processing apparatus 150.

### Second Exemplary Embodiment

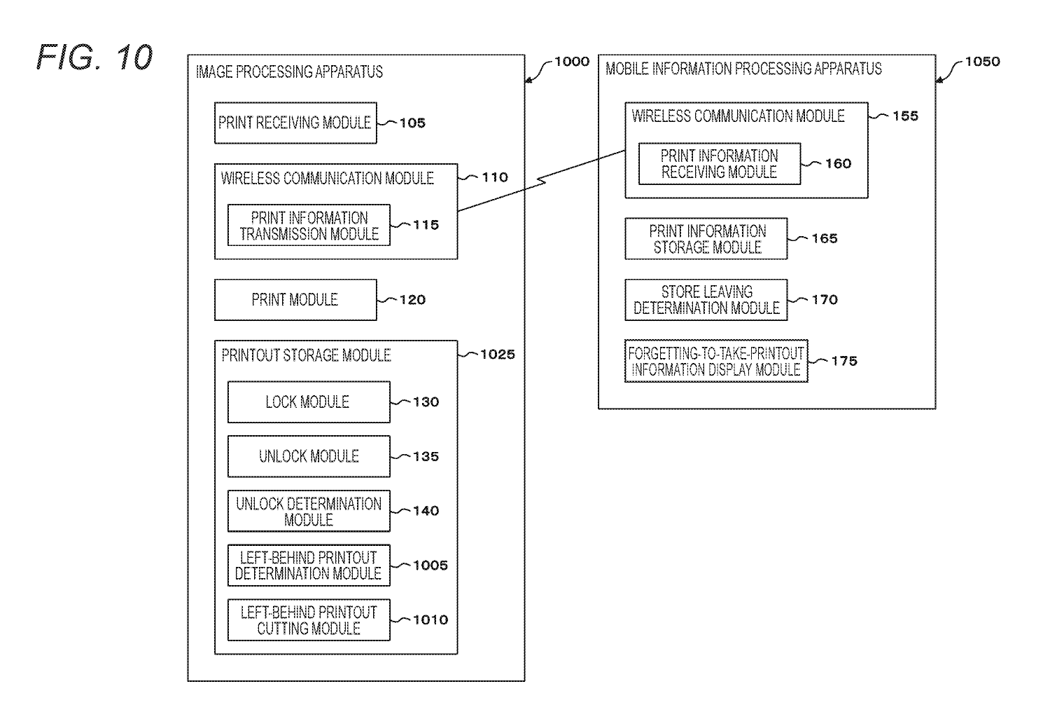

FIG. 10 is a conceptual module configuration diagram of a configuration example of a second exemplary embodiment. The same reference numerals are given to the same components as those of the above-described embodiment (hereinafter, this is the same).

In the first exemplary embodiment, there is a possibility that the printout is left behind due to the mobile information processing apparatus 150 that ran out of battery or an urgent work of the user. In a case where the state is maintained as it is, not only the capacity of the printout storage module 125 decreases, but also security problems remain due to the printout that is still left behind as it is, such as a problem in which the whole printout storage module 125 is stolen and the document in the printout storage module 125 is viewed by a third party. Therefore, after the lapse of a predetermined time, in a case where the printout is left behind in the printout storage module 125, the printout is shredded.

The image processing apparatus 1000 includes a print receiving module 105, a wireless communication module 110, a print module 120, and a printout storage module 1025. In a case where the printout is left behind, the image processing apparatus 1000 shreds the printout.

The wireless communication module 110 includes a print information transmission module 115.

The printout storage module 1025 includes a lock module 130, an unlock module 135, an unlock determination module 140, a left-behind printout determination module 1005, and a left-behind printout cutting module 1010.

The left-behind printout determination module 1005 determines whether or not the document stored in the printout storage module 1025 is a left-behind document. Specifically, after the printout is output, it may be determined whether or not a predetermined time has elapsed. Here, the “predetermined time” may be a predetermined time from the time of the final output of the printout, or a predetermined time from the time at which the printout is stored in the printout storage module 1025.

The left-behind printout cutting module 1010 has a function of the shredder, and cuts the document that is determined as a left-behind document by the left-behind printout determination module 1005. In other words, after the printout is output, in a case where the predetermined time has elapsed, the left-behind printout cutting module 1010 cuts the printout that is locked.

The left-behind printout is cut (discarded), and thus it is possible to prevent capacity shortage of the printout storage module 1025. The capacity shortage of the printout storage module 1025 is prevented, and thus a case where subsequent user cannot use the printout storage module 1025 is reduced. The left-behind printout is cut, and thus it is possible to prevent information leakage from the printout. The information leakage can be prevented, and thus it is possible to make the user feel secure.

The mobile information processing apparatus 1050 includes a wireless communication module 155, a print information storage module 165, a store leaving determination module 170, and a forgetting-to-take-printout information display module 175.

The wireless communication module 155 includes a print information receiving module 160.

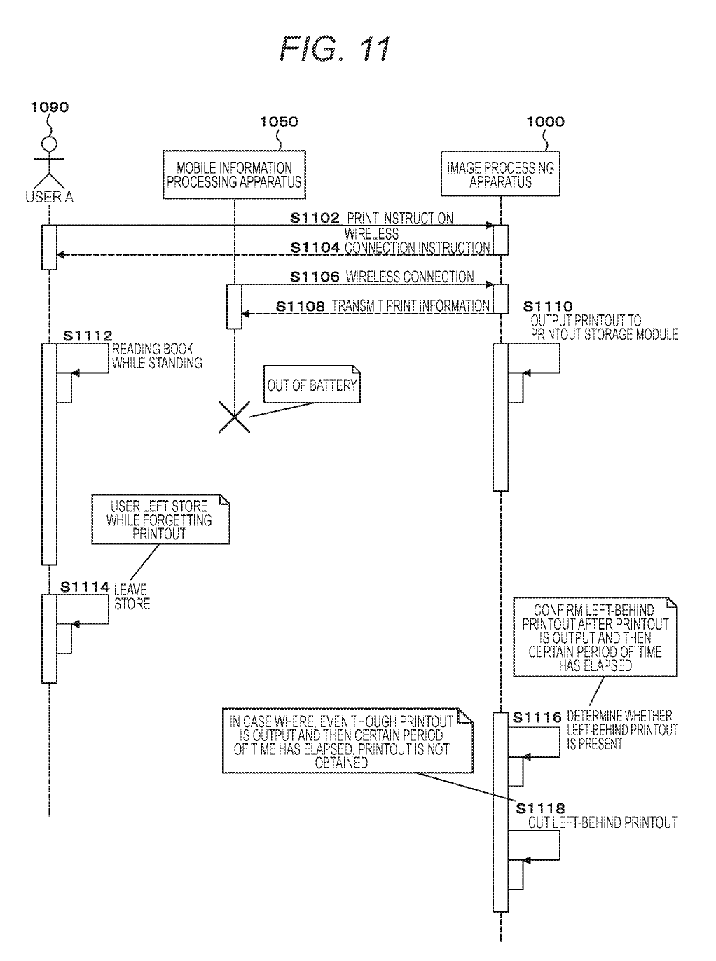

FIG. 11 is a flowchart illustrating a processing example according to the second exemplary embodiment. FIG. 11 illustrates the flow of the processing in a case where the mobile information processing apparatus 1050 is in a power-off state (for example, the battery thereof ran out, or the like) and user forgot to take the printout.

The processing from step S1102 to step S1112 is similar to the processing from step S802 to step S812 in the flowchart illustrated in the example of FIG. 8.

In step S1102, a user A 1090 instructs the image processing apparatus 1000 to print.

In step S1104, the image processing apparatus 1000 instructs the user A 1090 to perform wireless connection.

In step S1106, the mobile information processing apparatus 1050 performs wireless connection to the image processing apparatus 1000.

In step S1108, the image processing apparatus 1000 transmits the print information to the mobile information processing apparatus 1050.

In step S1110, the image processing apparatus 1000 outputs a printout to the printout storage module 1025.

In step S1112, the user A 1090 reads a book while standing. During the user A 1090 reads a book while standing, the mobile information processing apparatus 1050 runs out of battery.

In step S1114, the user A 1090 leaves the store.

Although the user A 1090 leaves the store forgetting to take the printout, the mobile information processing apparatus 1050 ran out of battery, and thus, at the time of leaving store, forgetting-to-take-printout information cannot be displayed on the mobile information processing apparatus 1050.

In step S1116, after the printout is output and then a certain period of time has elapsed, the image processing apparatus 1000 determines the presence of the left-behind printout.

After a predetermined time has elapsed, the printout that is output to the printout storage module 1025 is shredded.

In the determination processing of the left-behind printout determination module 1005, in addition to the condition that a predetermined time has elapsed, a condition that owner of the printout is still present at the store may be used, or these conditions may be used together.

Specifically, by using the wireless communication at the time of transmitting the print instruction, when the wireless communication is maintained as it is, the user is regarded as being present at the store, and thus it may be determined that the printout is not left behind.

When the wireless communication is not maintained, the user is regarded as left the store, and thus it may be determined that the printout is left behind.

In step S1118, in a case where, even though the printout is output and then a predetermined time has elapsed, the printout is not obtained, the image processing apparatus 1000 shreds the printout that is left behind.

### Third Exemplary Embodiment

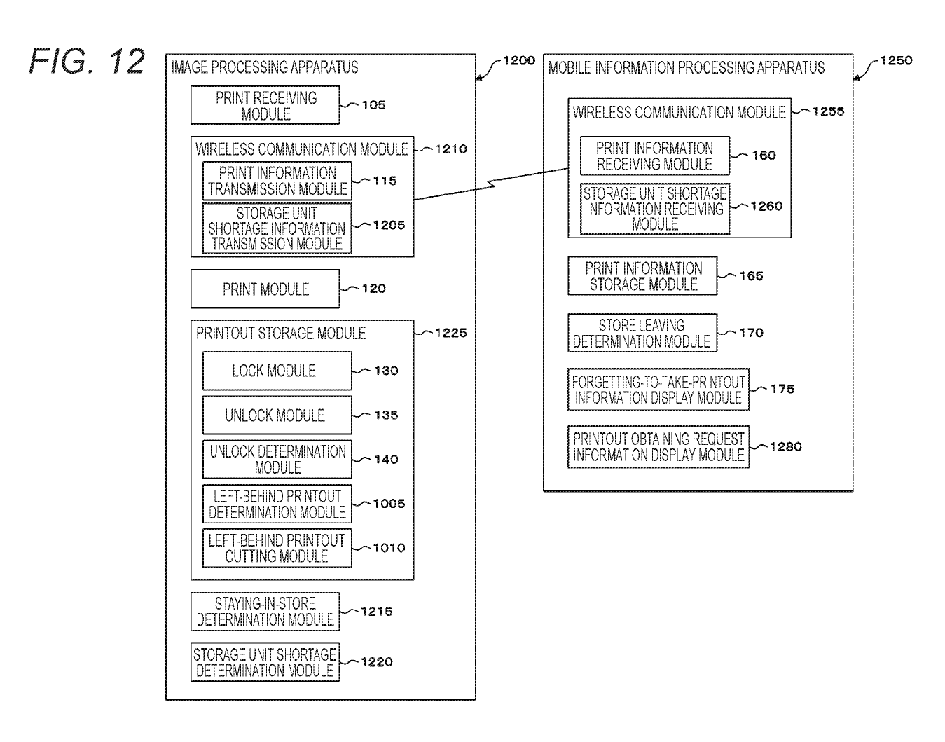

FIG. 12 is a conceptual module configuration diagram of a configuration example of a third exemplary embodiment.

In the first exemplary embodiment or the second exemplary embodiment, in a case where multiple users sequentially instruct printing, the capacity of the printout storage module (printout storage module 125, printout storage module 1025) is short, the following user cannot use the printout storage module.

In the second exemplary embodiment, even though there is room in the printout storage module, the printout is uniformly regarded as the printout being left behind by the elapse of a predetermined time, and thus the printout is shredded.

The image processing apparatus 1200 includes a print receiving module 105, a wireless communication module 1210, a print module 120, a printout storage module 1225, a staying-in-store determination module 1215, and a storage unit shortage determination module 1220.

The wireless communication module 1210 includes a print information transmission module 115 and a storage unit shortage information transmission module 1205.

The storage unit shortage information transmission module 1205 transmits the shortage information of the printout storage module 1225 (information indicating that the printout storage module 1225 is short), to the mobile information processing apparatus 1250 of the user who stays in the store and is the user (owner) of the printout, from the image processing apparatus 1200. In a case where it is determined that the owner of the printout still stays in the store by the staying-in-store determination module 1215, the storage unit shortage information transmission module 1205 may transmit the shortage information of the printout storage module 1225, to the mobile information processing apparatus 1250. In a case where the capacity of the printout storage module 1225 that stores the printout is short due to the printout, the storage unit shortage information transmission module 1205 transmits a message to request the obtaining of the printout, to the mobile information processing apparatus 1250. The destination of the message is the mobile information processing apparatus 1250 of the user who corresponds to the printout that is already printed but is not taken out from the storage cabinet.

The printout storage module 1225 includes a lock module 130, an unlock module 135, an unlock determination module 140, a left-behind printout determination module 1005, and a left-behind printout cutting module 1010.

The staying-in-store determination module 1215 determines whether or not the user (owner) of the printout that is stored in the printout storage module 1225 stays in the store. In a case where it is determined that the capacity of the printout storage module 1225 is short by the storage unit shortage determination module 1220, the staying-in-store determination module 1215 may determine whether or not the user (owner) of the printout that is stored in the printout storage module 1225 stays in the store.

The storage unit shortage determination module 1220 determines whether or not the capacity of the printout storage module 1225 is in a short state. In a case where the print receiving module 105 receives the print instruction, the storage unit shortage determination module 1220 may determine whether or not the capacity of the printout storage module 1225 is short by checking the status of the printout storage module 1225.

The mobile information processing apparatus 1250 includes a wireless communication module 1255, a print information storage module 165, a store leaving determination module 170, a forgetting-to-take-printout information display module 175, and a printout obtaining request information display module 1280.

The wireless communication module 1255 includes a print information receiving module 160 and a storage unit shortage information receiving module 1260.

The storage unit shortage information receiving module 1260 receives the shortage information of the printout storage module 1225, from the image processing apparatus 1200.

In a case where the shortage information of the printout storage module 1225 is received, when the information indicating that printing is in progress that is received from the image processing apparatus 1200 is held in the mobile information processing apparatus 1250, the printout obtaining request information display module 1280 displays the information that request the obtaining of the printout, on the mobile information processing apparatus 1250.

The obtaining of the printout is requested, and thus the printout is obtained from the printout storage module 1225.

Therefore, it is possible to solve the shortage state of the printout storage module 1225, and thus the following user can use the printout storage module 1225.

In a situation where the capacity of the printout storage module 1225 is not short, even though a predetermined time has elapsed, when the user (owner) of the printout still stays in the store, a flexible storage method such as a method by which the printout is not regarded as being left behind, is possible.

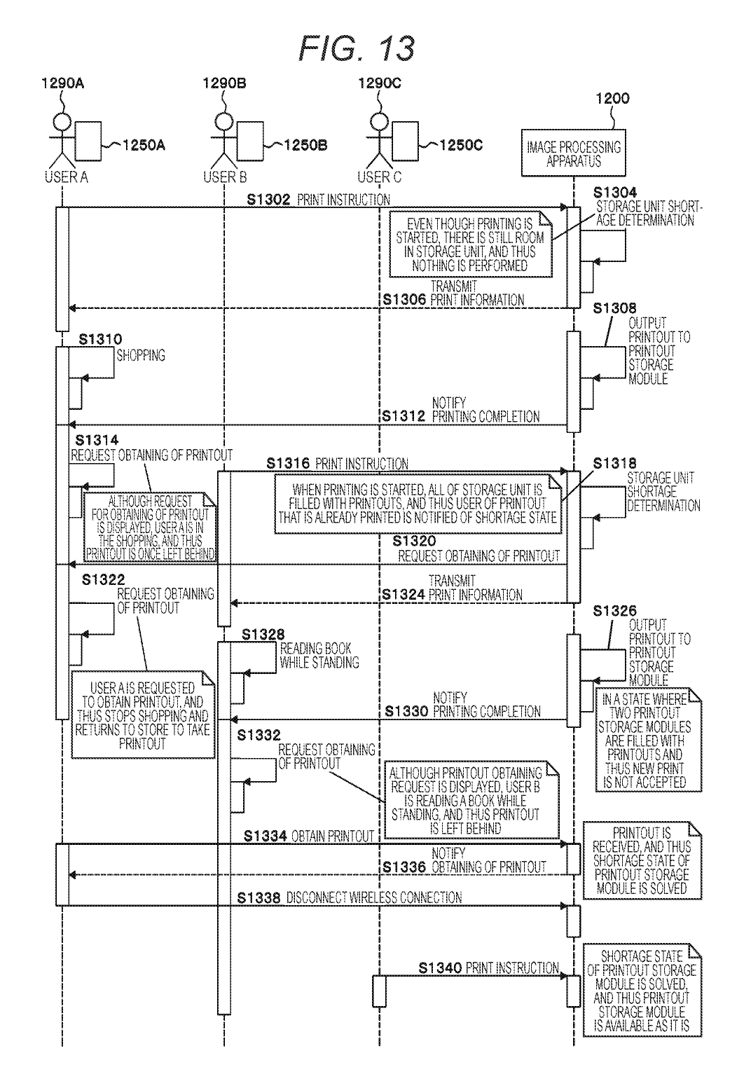

FIG. 13 is a flowchart illustrating a processing example according to the third exemplary embodiment. FIG. 13 illustrates the flow of the processing to request taking the printout by shortage situation of the printout storage module 1225. In FIG. 13, the processing example in a case where there are two output boxes 230 and the print instruction is performed by three users, is illustrated. The processing of the print instruction in the flowchart illustrated in the example of FIG. 13 (step S1302, step S1316, step S1340) is a collection of the processing from step S802 to step S806 in the flowchart illustrated in the example of FIG. 8, and in fact, includes the processing from step S802 to step S806.

In step S1302, a user A 1290A instructs the image processing apparatus 1200 to print.

In step S1304, the image processing apparatus 1200 performs a shortage determination of the printout storage module 1225. Even though printing is started, there is still room in the printout storage module 1225, and thus nothing is performed. In other words, the image processing apparatus 1200 confirms the shortage state of the printout storage module 1225.

Here, the capacity of the printout storage module 1225 is not in a short state, and thus nothing is performed.

As usual, the image processing apparatus 1200 instructs the mobile information processing apparatus 1250A of the user A 1290A to perform wireless connection to the image processing apparatus 1200. As usual, the mobile information processing apparatus 1250A of the user A 1290A performs wireless connection to the image processing apparatus 1200, and receives the print information using wireless communication.

In step S1306, the image processing apparatus 1200 transmits the print information to the user A 1290A.

In step S1308, the image processing apparatus 1200 outputs a printout to the printout storage module 1225. In other words, the image processing apparatus 1200 starts printing that is instructed. The printout is output to the printout storage module 1225 that is locked.

In step S1310, the user A 1290A does shopping. In other words, the user A 1290A does shopping in the store using the print time.

In step S1312, the image processing apparatus 1200 notify the user A 1290A of printing completion. In other words, when printing is completed, the image processing apparatus 1200 notifies the mobile information processing apparatus 1250A of the user A 1290A of printing completion. In the case where the user A 1290A stays in the store, the user A 1290A may be notified.

In step S1314, the user A 1290A requests obtaining of the printout. Although the request for obtaining of the printout is displayed, the user A 1290A is in the shopping, and thus the printout is once left behind. In other words, the mobile information processing apparatus 1250A of the user A 1290A performs the notification of the printout obtaining request information in the mobile information processing apparatus 1250A. However, the user A 1290A is in the shopping, and thus the user A 1290A once ignore this notification.

In step S1316, the user B 1290B instructs the image processing apparatus 1200 to print.

In step S1318, the image processing apparatus 1200 performs a shortage determination of the printout storage module 1225. When printing is started, the entire printout storage module 1225 are filled with printouts, the user of the printout that is already printed is notified of the shortage state. In other words, the image processing apparatus 1200 confirms the shortage state of the printout storage module 1225.

Here, as the user B 1290B performs printing, all of the printout storage module 1225 is filled, and thus the user of the printout that is output (in this case, the user A 1290A) is notified of printout obtaining request. Then, the user B 1290B transmits the print information to the mobile information processing apparatus 1250B.

In step S1320, the image processing apparatus 1200 requests the user A 1290A to obtain the printout.

In step S1322, the user A 1290A is requested to obtain the printout. The user A 1290A is requested to obtain the printout, and thus stops shopping and returns to the store to take the printout. In other words, the mobile information processing apparatus 1250A of the user A 1290A is notified of printout obtaining request from the image processing apparatus 1200, and performs printout obtaining request in the mobile information processing apparatus 1250A. Therefore, the user A 1290A returns to the image processing apparatus 1200 in order to obtain the printout. The order of the notification to the user of the printout that is output and the order of the transmission of the print information for the new job may be changed.

In step S1324, the image processing apparatus 1200 transmits the print information to the user B 1290B.

In step S1326, the image processing apparatus 1200 outputs a printout to the printout storage module 1225. Since the two printout storage modules 1225 are filled, the image processing apparatus 1200 is in a state where a new print is not accepted. In other words, the image processing apparatus 1200 starts printing that is requested by the user B 1290B. The printed paper is output to the printout storage module 1225 that is locked.

In step S1328, the user B 1290B reads a book in the store while standing using the print time.

In step S1330, the image processing apparatus 1200 notifies the user B 1290B of printing completion. In other words, when the printing is completed, the image processing apparatus 1200 notifies the mobile information processing apparatus 1250B of the user B 1290B of printing completion. In a case where it is determined that the user B 1290B stays in the store, the user B 1290B may be notified.

In step S1332, the user B 1290B is requested to obtain the printout. Although printout obtaining request is displayed, the user B 1290B reads a book, and thus the printout is left behind. In other words, the mobile information processing apparatus 1250B of the user B 1290B notifies the printout obtaining request information using the display device of the mobile information processing apparatus 1250B. However, the user B 1290B reads a book while standing, and thus the notification is left behind.

In step S1334, the user A 1290A obtains the printout from the image processing apparatus 1200. The printout is received, and thus the shortage state of the printout storage module 1225 is solved.

In other words, the user A 1290A stops shopping, and obtains the printout from the printout storage module 1225 of the image processing apparatus 1200. When the printout is obtained, the image processing apparatus 1200 notifies the mobile information processing apparatus 1250A of the user A 1290A of printout obtaining. When printout obtaining is notified, the mobile information processing apparatus 1250A removes the printout information that is held. Alternately, the print flag may be set to OFF.

In step S1336, the image processing apparatus 1200 notifies the mobile information processing apparatus 1250A of the user A 1290A of printout obtaining.

In step S1338, the mobile information processing apparatus 1250A of the user A 1290A disconnects wireless connection to the image processing apparatus 1200.

In step S1340, the user C 1290C instructs the image processing apparatus 1200 to print. Since the shortage state of the printout storage module 1225 is solved, and thus the printout storage module 1225 is available as it is. In other words, the user C 1290C performs a print instruction on the image processing apparatus 1200. Since there is room in the printout storage module 1225, the printout storage module 1225 is available, as usual.

The capacity of the printout storage module 1225 is in a short state again by a print instruction of the user C 1290C, and thus the printout obtaining request notification is transmitted to the user B 1290B.

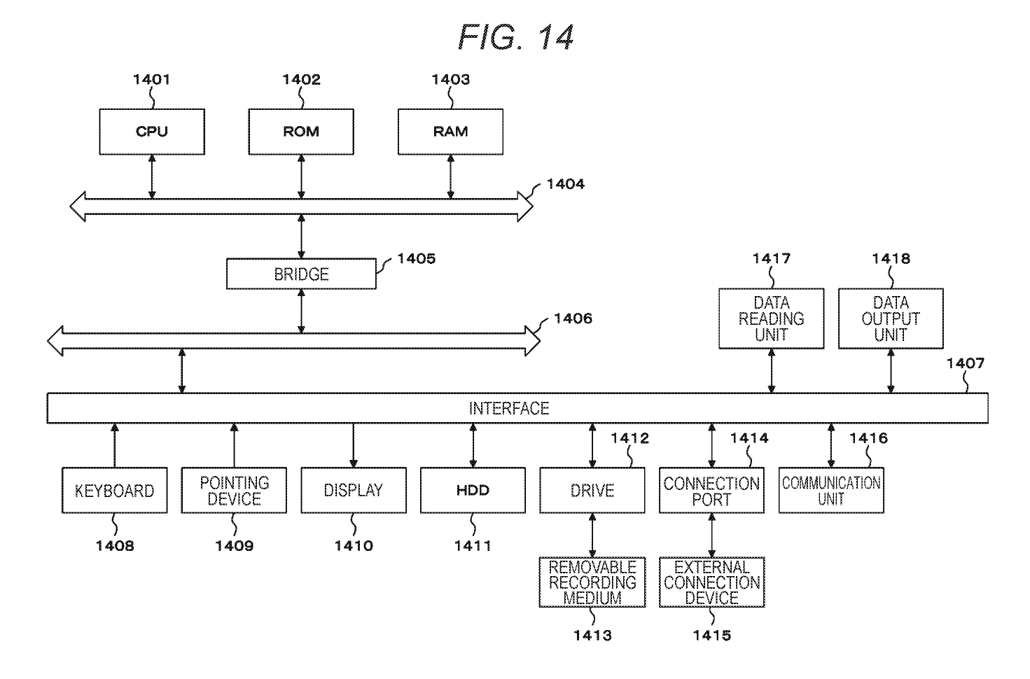

With reference to FIG. 14, a description will be given of a hardware configuration example of the image processing apparatus according to present exemplary embodiment (image processing apparatus 100, image processing apparatus 1000, and image processing apparatus 1200). The configuration illustrated in FIG. 14 is achieved by, for example, a personal computer (PC) or the like.

FIG. 14 illustrates a hardware configuration example including a data reading unit 1417 such as a scanner, and a data output unit 1418 such as a printer.

The central processing unit (CPU) 1401 is a controller for executing the processing according to a computer program that describes the execution sequence of various modules described in the exemplary embodiments, that is, each module such as the print receiving module 105, the wireless communication module 110, the wireless communication module 1210, the print information transmission module 115, the storage unit shortage information transmission module 1205, the print module 120, the printout storage module 125, the printout storage module 1025, the printout storage module 1225, the lock module 130, the unlock module 135, the unlock determination module 140, the left-behind printout determination module 1005, the left-behind printout cutting module 1010, the staying-in-store determination module 1215, and the storage unit shortage determination module 1220.

A read only memory (ROM) 1402 stores programs and operation parameters used by the CPU 1401. A random access memory (RAM) 1403 stores programs used in execution of the CPU 1401, parameters that appropriately vary in the execution, and the like. The CPU 1401, the ROM 1402, and the RAM 1403 are connected to each other via a host bus 1404 including a CPU bus or the like.

The host bus 1404 is connected to an external bus 1406 such as peripheral component interconnect/interface (PCI) bus, via a bridge 1405.

A keyboard 1408 and a pointing device 1409 such as a mouse are a device that is operated by an operator. A display 1410 is a liquid crystal display device, a cathode ray tube (CRT), or the like, and displays various information as text or image information. A touch screen or the like that has a function of both of the pointing device 1409 and the display 1410, may be used.

A hard disk drive (HDD) 1411 incorporates a hard disk (a flash memory or the like may be used), and drives the hard disk to record or reproduce programs and information that are executed by the CPU 1401.

Print document data, print information, or the like is stored in the hard disk. In addition, various data, various computer programs, and the like are stored.

A drive 1412 reads data or program recorded in a magnetic disk, an optical disk, a magneto-optical disk that are mounted, or a removable recording medium 1413 such as a semiconductor memory, and supplies the data or program to the RAM 1403 that is connected via an interface 1407, the external bus 1406, the bridge 1405, and the host bus 1404. The removable recording medium 1413 is also available as a data recording area.

A connection port 1414 is a port for connecting an external connection device 1415, and includes a connection such as USB, IEEE1394, or the like. The connection port 1414 is connected to the CPU 1401 and the like via an interface 1407, the external bus 1406, the bridge 1405, the host bus 1404, and the like. A communication unit 1416 is connected to communication line, and executes data communication processing with the external. The data reading unit 1417 is, for example, a scanner, and executes the reading processing of a document. The data output unit 1418 is, for example, a printer, and performs the output processing of document data.

The hardware configuration of the image processing apparatus illustrated in FIG. 14 is a configuration example.

The present exemplary embodiment is not limited to the configuration illustrated in FIG. 14, and may have a configuration that can execute the modules described in present exemplary embodiment. For example, some modules may be configured by a dedicated hardware (for example, application specific integrated circuit (ASIC), or the like).

Alternately, some modules may be provided in an external system and connected to other modules via communication lines.

Further, several systems illustrated in FIG. 14 may be connected with each other via communication lines and cooperate with each other.

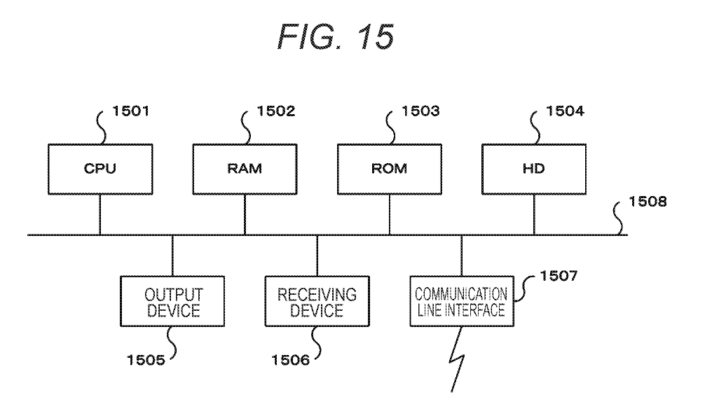

As illustrated in FIG. 15, the hardware configuration of the mobile information processing apparatus (mobile information processing apparatus 150, mobile information processing apparatus 1050, and mobile information processing apparatus 1250) as computer that is executed by a program according to the present exemplary embodiment is a general computer.

Specifically, the computer is a mobile phone, a notebook PC, or the like. That is, as a specific example, the CPU 1501 is used as a processing unit (calculation unit), the RAM 1502, the ROM 1503, the HD 1504 are used as a memory device. As HD 1504, for example, a hard disk or solid state drive (SSD) may be used. The computer includes: the CPU 1501 that executes the program of the module such as the wireless communication module 155, the wireless communication module 1255, the print information receiving module 160, the storage unit shortage information receiving module 1260, the print information storage module 165, the store leaving determination module 170, the forgetting-to-take-printout information display module 175, the printout obtaining request information display module 1280, and the like; the RAM 1502 that stores the program and the data; the ROM 1503 that stores the program or the like for driving the computer; the HD 1504 that is an auxiliary memory device (which may be a flash memory or the like); a receiving device 1506 that receives data based on the operation of the user using a keyboard, a mouse, a touch screen, a microphone, or the like; a liquid crystal display; an output device 1505 such as a speaker; a communication line interface 1507 for connecting to a communication network such as a network interface card; and a bus 1508 for exchanging data by using the components.

Among the exemplary embodiments, the exemplary embodiment according to the computer program can be realized by loading the computer program as software into the system of the hardware configuration and cooperating with the software and the hardware resources.

The hardware configuration of the image processing apparatus illustrated in FIG. 15 is a configuration example.

The present exemplary embodiment is not limited to the configuration illustrated in FIG. 15, and may have a configuration that can execute the modules described in present exemplary embodiment. For example, some modules may be configured by a dedicated hardware (for example, application specific integrated circuit (ASIC), or the like).

Alternately, some modules may be provided in an external system and connected to other modules via communication lines.

Further, several systems illustrated in FIG. 15 may be connected with each other via communication lines and cooperate with each other.

In the exemplary embodiment described above, although the printout is stored, the original document in copying functions or the document in scan functions may be used as a storage target.

Further, in the comparison processing in the description of the exemplary embodiment, “equal to or larger than”, “equal to or less than”, “greater than”, and “smaller than (less than)” may be “greater than”, “smaller than (less than)”, “equal to or larger than”, and “equal to or less than (less than)”, respectively, so far as may be consistent in combination thereof.

The technique described in the background art as the processing contents of each module may be employed.

The above-described program may be provided by storing in a recording medium, or may also be provided via a communication tool. In this case, for example, the above-described program may be included in the exemplary embodiment of the invention as “computer readable recording medium storing a program”.

The “computer readable recording medium storing a program” refers to a computer readable recording medium storing a program that is used for a program installation, an execution, a program distribution, and the like.

The recording medium includes, for example, a digital versatile disk (DVD), “DVD-R, DVD-RW, DVD-RAM, or the like” as a standard defined by the DVD forum, “DVD+R, DVD+RW, or the like” as a standard defined by DVD+RW, a CD read only memory (CD-ROM), a CD recordable (CD-R), a CD rewritable (CD-RW), or the like as a compact disk (CD), a Blu-ray disc (registered trademark), a magneto-optical disk (MO), a flexible disk (FD), a magnetic tape, a hard disk, a read-only memory (ROM), an electrically erasable and programmable read-only memory (EEPROM) (registered trademark), a flash memory, a random access memory (RAM), a secure digital (SD) memory card, and the like.

The whole or a part of the program may be recorded on the recording medium and then stored or distributed. Further, the program may be transmitted using communication such as a wired network that is used in a local area network (LAN), a metropolitan area network (MAN), a wide area network (WAN), an internet, an intranet, an extranet, or the like, or wireless communication network, or using a transmission medium such as combinations thereof.

Alternatively, the program may be transmitted on a carrier wave.

Further, the program may be a part or all of other programs, or may be recorded on a recording medium together with another program. Alternatively, the program may be divided and recorded on multiple recording media. Further, the program may be recorded in restorable any manner such as compression, encryption, or the like.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A mobile apparatus comprising:
a communication unit that performs wireless communication with an image processing apparatus;
a first receiving unit that receives information indicating that printing is in progress from the image processing apparatus;
a second receiving unit that receives information indicating that printing is completed from the image processing apparatus; and
an output unit,
wherein when a connection state in the wireless communication with the image processing apparatus or a distance to the image processing apparatus satisfies a predetermined condition after the information indicating that printing is in progress is received from the image processing apparatus and before the information indicating that printing is completed is received from the image processing apparatus, the output unit outputs a message indicating that a printout output by the image processing apparatus is forgotten to be taken.

2. The mobile apparatus according to claim 1,
wherein the predetermined condition is at least one of:
a condition that a radio wave intensity or a signal noise ratio of the wireless communication with the image processing apparatus satisfies a predetermined condition, and
a condition that the distance to the mobile apparatus is larger than a predetermined second threshold value, or equal to or larger than the predetermined second threshold value.

3. An image processing apparatus comprising:
a communication unit that performs wireless communication with a mobile apparatus;
a first transmission unit that transmits information indicating that printing is in progress to the mobile apparatus;
a lock unit that locks a printout output by the image processing apparatus to prevent from being taken out; and
a second transmission unit that transmits information indicating that printing is completed to the mobile apparatus when the lock is unlocked.

4. The image processing apparatus according to claim 3 further comprising:
a shredding unit that shreds the locked printout when a predetermined time has elapsed after the printout is output.

5. The image processing apparatus according to claim 1 further comprising:
a third transmission unit that transmits a message to request obtaining of the printout to the mobile apparatus when a capacity of a storage unit that stores the printout is short due to the printout.

6. The image processing apparatus according to claim 2 further comprising:
a third transmission unit that transmits a message to request obtaining of the printout to the mobile apparatus, when a capacity of a storage unit that stores the printout is short due to the printout.

7. An image processing system comprising:
a mobile apparatus; and
an image processing apparatus,
wherein the mobile apparatus includes:
a communication unit that performs wireless communication with an image processing apparatus;
a first receiving unit that receives information indicating that printing is in progress from the image processing apparatus;
a second receiving unit that receives information indicating that printing is completed from the image processing apparatus; and
an output unit,
wherein when a connection state in the wireless communication with the image processing apparatus or a distance to the image processing apparatus satisfies a predetermined condition after the information indicating that printing is in progress is received from the image processing apparatus and before the information indicating that printing is completed is received from the image processing apparatus, the output unit outputs a message indicating that a printout output by the image processing apparatus is forgotten to be taken, and
wherein the image processing apparatus includes:
a communication unit that performs wireless communication with a mobile apparatus;
a first transmission unit that transmits information indicating that printing is in progress to the mobile apparatus;
a lock unit that locks a printout output by the image processing apparatus to prevent from being taken out; and
a second transmission unit that transmits information indicating that printing is completed to the mobile apparatus when the lock is unlocked.

8. A non-transitory computer readable medium storing a mobile terminal processing program causing a computer to function as:
a communication unit that performs wireless communication with an image processing apparatus;
a first receiving unit that receives information indicating that printing is in progress from the image processing apparatus;
a second receiving unit that receives information indicating that printing is completed from the image processing apparatus; and
an output unit,
wherein when a connection state in the wireless communication with the image processing apparatus or a distance to the image processing apparatus satisfies a predetermined condition after the information indicating that printing is in progress is received from the image processing apparatus and before the information indicating that printing is completed is received from the image processing apparatus, the output unit outputs a message indicating that a printout output by the image processing apparatus is forgotten to be taken.

9. A non-transitory computer readable medium storing an image processing program causing a computer to function as:
a communication unit that performs wireless communication with a mobile apparatus;
a first transmission unit that transmits information indicating that printing is in progress to the mobile apparatus;
a lock unit that locks a printout output by the image processing apparatus so as not to be taken; and
a second transmission unit that transmits information indicating that printing is completed to the mobile apparatus when the lock is unlocked.
